(19) United States
(12) Patent Application Publication
(10) Pub. No.: US 2026/0361486 A1
(43) Pub. Date: Nov. 12, 2026

(54) DYNAMIC DMRS CONFIGURATION FOR UPLINK TRANSMISSION

(71) Applicant: Nokia Technologies Oy, Espoo (FI)

(72) Inventors: Timo KOSKELA, Oulu (FI); Juha Pekka KARJALAINEN, Oulu (FI); Sami-Jukka HAKOLA, Oulu (FI); Mihai ENESCU, Espoo (FI)

(21) Appl. No.: 19/102,946

(22) PCT Filed: Sep. 7, 2023
(86) PCT No.: PCT/EP2023/074535

§ 371 Date: Feb. 11, 2025

(30) Foreign Application Priority Data
Sep. 30, 2022 (GB) 2214402.6

(51) Int. Cl. H04L 5/00; H04W 72/231

(52) U.S. Cl. CPC H04L 5/0051; H04W 72/231

(57) ABSTRACT

Embodiments of the present disclosure relate to apparatuses, methods, and computer readable storage media of dynamic demodulation reference signal (DMRS) configuration for uplink transmission. An apparatus receives at least one higher layer parameter configuring a first DMRS configuration type and a second DMRS configuration type. The apparatus receives at least one of: a first indication of at least one transmission parameter related to at least one uplink transmission, or a second indication indicative of the first DMRS configuration type or the second DMRS configuration type to be applied for the at least one uplink transmission. Then, the apparatus determines at least one of the first or second DMRS configuration type based on the at least one of the first or second indication. The apparatus performs the at least one uplink transmission by using the at least one of the determined first or second DMRS configuration type.

### FIELDS

Various example embodiments of the present disclosure generally relate to the field of telecommunication and in particular, to methods, apparatuses and computer readable storage medium of dynamic demodulation reference signal (DMRS) configuration for uplink transmission.

### BACKGROUND

In multi-transmission reception point (multi-TRP) deployment, a UE may be capable of multiple transmission panels and may operate using different antenna panels for different links. In multiple TRP communication, a UE may be configured with transmission and reception using multiple links and the links may have independent properties or characteristics. However, there is no signaling framework that may be able to support a dynamic change of uplink transmission parameters based on the uplink transmission assumptions.

### SUMMARY

In a first aspect of the present disclosure, there is provided a first device. The first device comprises at least one processor; and at least one memory storing instructions that, when executed by the at least one processor, cause the apparatus at least to perform: receiving at least one higher layer parameter configuring a first demodulation reference signal (DMRS) configuration type and a second DMRS configuration type; receiving at least one of: a first indication of at least one transmission parameter related to at least one uplink transmission, or a second indication indicative of the first DMRS configuration type or the second DMRS configuration type to be applied for the at least one uplink transmission; determining at least one of the first or second DMRS configuration type based on the at least one of the first or second indication; and performing the at least one uplink transmission by using the at least one of the determined first or second DMRS configuration type.

In a second aspect of the present disclosure, there is provided a second device. The second device comprises at least one processor; and at least one memory storing instructions that, when executed by the at least one processor, cause the apparatus at least to perform: transmitting at least one higher layer parameter configuring a first demodulation reference signal (DMRS) configuration type and a second DMRS configuration type; determining at least one of the first or second DMRS configuration type for at least one uplink transmission; transmitting at least one of: a first indication of at least one transmission parameter related to the at least one uplink transmission, or a second indication indicative of the first DMRS configuration type or the second DMRS configuration type to be applied for the at least one uplink transmission; receiving the at least one uplink transmission by using the determined at least one of the first or second DMRS configuration type.

In a third aspect of the present disclosure, there is provided a method. The method comprises: at a first device, receiving at least one higher layer parameter configuring a first demodulation reference signal (DMRS) configuration type and a second DMRS configuration type; receiving at least one of: a first indication of at least one transmission parameter related to at least one uplink transmission, or a second indication indicative of the first DMRS configuration type or the second DMRS configuration type to be applied for the at least one uplink transmission; determining at least one of the first or second DMRS configuration type based on the at least one of the first or second indication; and performing the at least one uplink transmission by using the at least one of the determined first or second DMRS configuration type.

In a fourth aspect of the present disclosure, there is provided a method. The method comprises: at a second device, transmitting at least one higher layer parameter configuring a first demodulation reference signal (DMRS) configuration type and a second DMRS configuration type; determining at least one of the first or second DMRS configuration type for at least one uplink transmission; transmitting at least one of: a first indication of at least one transmission parameter related to the at least one uplink transmission, or a second indication indicative of the first DMRS configuration type or the second DMRS configuration type to be applied for the at least one uplink transmission; receiving the at least one uplink transmission by using the determined at least one of the first or second DMRS configuration type.

In a fifth aspect of the present disclosure, there is provided an apparatus. The apparatus comprises means for receiving at least one higher layer parameter configuring a first demodulation reference signal (DMRS) configuration type and a second DMRS configuration type; means for receiving at least one of: a first indication of at least one transmission parameter related to at least one uplink transmission, or a second indication indicative of the first DMRS configuration type or the second DMRS configuration type to be applied for the at least one uplink transmission; means for determining at least one of the first or second DMRS configuration type based on the at least one of the first or second indication; and means for performing the at least one uplink transmission by using the at least one of the determined first or second DMRS configuration type.

In a sixth aspect of the present disclosure, there is provided an apparatus. The apparatus comprises means for transmitting at least one higher layer parameter configuring a first demodulation reference signal (DMRS) configuration type and a second DMRS configuration type; means for determining at least one of the first or second DMRS configuration type for at least one uplink transmission; means for transmitting at least one of: a first indication of at least one transmission parameter related to the at least one uplink transmission, or a second indication indicative of the first DMRS configuration type or the second DMRS configuration type to be applied for the at least one uplink transmission; means for receiving the at least one uplink transmission by using the determined at least one of the first or second DMRS configuration type.

In a seventh aspect of the present disclosure, there is provided a computer readable medium. The computer readable medium comprises instructions stored thereon for causing an apparatus to perform at least the method according to the third aspect.

In a eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a diagram of example structures of two DMRS configuration types according to some example embodiments of the present disclosure.;

FIG. 3 illustrates an example signaling diagram of a communication process between two apparatuses according to some example embodiments of the present disclosure;

FIG. 4 illustrates a flowchart of a method according to some example embodiments of the present disclosure;

FIGS. 5A and 5B illustrate flowcharts of example processes to enable a dynamic indication for a DMRS configuration type according to some example embodiments of the present disclosure;

FIG. 6 illustrates a flowchart of a method according to some example embodiments of the present disclosure;

FIG. 7 illustrates a simplified block diagram of an apparatus that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprise”, “comprising”, “have”, “having”, “include” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a transmission reception point (TRP), such as a base station (BS), an access point (AP), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), a mobile device, a user device, or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

Multiple timing advance (TA) operation per serving cell/timing advance group (TAG) may need to be supported for multi-downlink control information (multi-DCI) multi-TRP (also called multiple TRP, multiple-TRP or mTRP) operation. For example, multiple TA values may be used in the multi-DCI multi-TRP (also called multi-DCI based multi-TRP) operation. The timing advance value indicates the required advancement of uplink transmission with respect the downlink reference timing so that different transmissions from different user equipment (UEs) arrive within a time window such as a cyclic prefix in an Orthogonal Frequency Division Multiple (OFDM) symbol. In previous releases, the TA value may be configured to be different for different cells (for example, different TA values for different TAGs). In the multiple TRP operation, the uplink timing may be needed per TRP (for example, per uplink transmission link). For multi-DCI based multi-TRP operation with two TAS, it may be supported to configure two TAGs (and/or two TA values to be maintained for a serving cell, or for a serving cell and a cell with different PCI than serving cell) belonging to a serving cell.

In multi-TRP deployment, as an example, a UE may be capable of multiple transmission panels and may operate using different antenna panels for different links (this could enable, for example, simultaneous multipanel/multibeam transmission. Alternatively, the UE may operate with one antenna panel but may use different beams per panel for different uplinks. The UE may have separate links with different path losses (for example, due to distance) toward different TRPs.

A unified transmission configuration indicator (TCI) framework is introduced in Release 17 (Rel-17). In the unified TCI framework, TCI states so far providing Quasi co-location (QCL) assumptions for reception of downlink (DL) signals and channels would be used also to provide spatial sources for transmission of uplink (UL) signals and channels. Furthermore, the unified TCI framework defines the concept of an indicated TCI state. The indicated TCI state can be joint DL and UL TCI state or separate DL and separate UL TCI states. The indicated TCI state provides QCL source (DL) and spatial source (UL) for a set of downlink signals and channels and for a set of uplink signals and channels, respectively. In Rel-17, there can be one indicated joint DL and UL TCI state or one indicated DL TCI state and one indicated UL TCI state for the UE.

In the unified TCI framework, one or more TCI state IDs may be configured/indicated for a set of signals and channels at a time which may be a joint DL/UL TCI state, or a separate DL TCI state, or a separate UL TCI state. The indicated TCI state may comprise of a TCI state ID which is indicated to be used as joint DL/UL, DL and/or UL TCI state. One or more TCI state IDs can be configured/indicated to be the one or more indicated TCI states (e.g. first indicated or second indicated TCI state). A set (or pool or list) of joint and/or separate TCI states may be configured via Radio Resource Control (RRC) signaling. A number (for example, 8) of joint and/or separate TCI states may be activated via Media Access Control (MAC) signaling such as a MAC control element (CE).

One of the activated TCI states (a list of TCI state IDs) may be indicated via DCI to be applied. Such a TCI state may also be referred to as an indicated TCI state (i.e., a TCI state ID is considered as indicated TCI state ID). Instead of the indication via DCI indicative of which TCI state to be applied, the TCI state activated by a MAC CE, if there is only one activated TCI state, may considered as the TCI state to be currently applied, or the current indicated TCI state.

DCI format 1_1/1_2 with and without DL assignment may be used to carry the TCI state indication. The indication may be confirmed by hybrid automatic repeat request (HARQ) acknowledgement (ACK) from a UE. The application time of the TCI state indication may the first slot that is at least X ms or Y symbols after the last symbol of the acknowledgment of the joint or separate DL/UL TCI state indication. The TCI field codepoint may indicate a joint TCI state for both DL and UL, a pair of a DL TCI state and a UL TCI state, or a DL TCI state (keep the current UL TCI state) or a UL TCI state (keep the current DL TCI state).

Two different configuration types of DMRS, referred to as type 1 (type-1) and type 2 (or type-2) respectively, may be supported in New Radio (NR). The configuration type 1 has so called comb-2 structure meaning that every second resource element (RE) of resource elements within a configured physical resource blocks (PRBs) is allocated for antenna ports associated with corresponding resources. As a result of this, antenna ports can be multiplexed in frequency domain where antenna ports sharing the same resource elements are differentiated using orthogonal cover code (OCC) enabling code division multiplexing (CDM). Type-1 provides support for 4-antenna ports per symbols and with double front-loaded symbols up to 8 antenna panels (APs). Type-1 DMRS may be configured in presence of poor/limited coverage conditions.

In type 2 configuration, every 3rd pair of subcarriers is allocated for antenna ports associated with corresponding resource elements within configured PRBs. Type-2 provides support for 6-antenna ports per symbols and with double front-loaded symbols up to 12 APs. Type-2 may be used for less challenging channel conditions with respect to type-1 (enabling higher multiplexing capacity).

In Release 17, the multiple TRP operation was defined for downlink only. The multiple TRP operation needs to be extended for uplink. In multiple TRP communication, a UE may be configured with transmission and reception using multiple links and the links may have independent properties or characteristics. One of these properties is the distance (that affects directly traverse time of the signal) and channel conditions of the particular link. For example, in typical systems using multiple beams for operation, the link may be considered as power limited instead of interference limited. Thus, in the power limited case, the distance/path loss of the link may affect the required uplink transmission properties.

The traverse time of the signal may be considered to be handled by the introduction of multiple TA values. For example, different links may have different propagation delays (due to distance) and may operate using different TA values. TA values can be updated by the network in dynamic manner. However, another multi-TRP related problem is demodulation reference signal (DMRS) based channel estimation. Different links would require potentially different DMRS configuration types depending on the used TRP for the links. In addition, a link to a TRP may be switched towards a further TRP which may have different transmission assumptions (for example, different path loss) for uplink transmission. The transmission switch may mean that the UE receives an indication of a new TCI state ID which is configured/indicated as the indicated TCI state, and thus the DMRS configuration type would benefit on dynamic switching capability (especially in the multiple TRP deployments).

The current signaling framework is not able to support a dynamic change of uplink transmission parameters based on the uplink transmission assumptions. One of the key issues is related to an uplink DMRS that are used for uplink channel estimation. The DMRS configuration in NR the fifth generation (5G) supports 2 different values (type 1 and type 2) and are suitable for different channel conditions where the type 1 is considered to be more robust due to the RE density compared to the type 2. In return, the type 1 configuration limits the multiplexing capability of different UEs due to the RS density. Thus, the preferred or optimum configuration would depend on the UL transmission characteristics of the link and thus a static value (or RRC configured value) may limit the scheduling flexibility of the network, it may decrease the efficiency of the resource usage and may cause unnecessary delays for uplink beam changes in case an RRC level reconfiguration is needed before the beam change.

One other example of such a parameter that may be dynamically changed is the DMRS mapping to specific symbols in a slot. For example, a downlink message (e.g., a DCI or MAC CE) may indicate a DMRS symbol mapping type to the PUSCH resources (for example, mapping Type A or B, or dmrs-UplinkForPUSCH-MappingTypeA or dmrs-UplinkForPUSCH-MappingTypeB) per transmission (e.g., in a DCI) or in a semi-static manner (in a MAC CE for a specific TCI state or indicated TCI states). In one example, the DMRS configuration type and DMRS for PUSCH mapping type may be dynamically indicated/changed. As an example, dmrs-UplinkForPUSCH-MappingTypeA/B may refer to the DMRS symbol positions in a slot.

Example embodiments of the present disclosure propose an enhanced scheme to support a dynamic change of uplink transmission parameters in multi-TRP deployment. The scheme allows an apparatus (for example, a UE) to determine one or more DMRS configuration types (such as type 1 and/or type 2) for one or more uplink transmissions based on a dynamic indication from the network. In some examples, the scheme allows an apparatus to determine one or more DMRS configuration types for downlink reception. The DMRS configuration type is determined from a plurality of DMRS configuration types that may be configured via RRC signaling. The dynamic indication comprises a first indication of at least one transmission parameter related to the uplink transmissions, and/or a second indication indicative of one DMRS configuration type (either type 1 or type 2) to be applied for the uplink transmissions.

In this way, the used DMRS configuration type may be dynamically indicated and determined. Different number of resource elements may be used for the first and second DMRS configuration types which enable the efficient UL operation. Thereby, scheduling flexibility may be increased while achieving more efficient transmission resource utilization. In some embodiments, a DMRS configuration type may also be referred to as a configuration type.

In some example embodiments, the similar methods may be applied for downlink DMRS (used for downlink transmission reception by the UE). The Network (e.g., a TRP/gNB) may indicate in a downlink message that a specific DMRS configuration or configuration type may be used for demodulation purposes of the scheduled physical downlink shared channel (PDSCH). This indication may be provided, e.g., in a DCI message scheduling the PDSCH transmission.

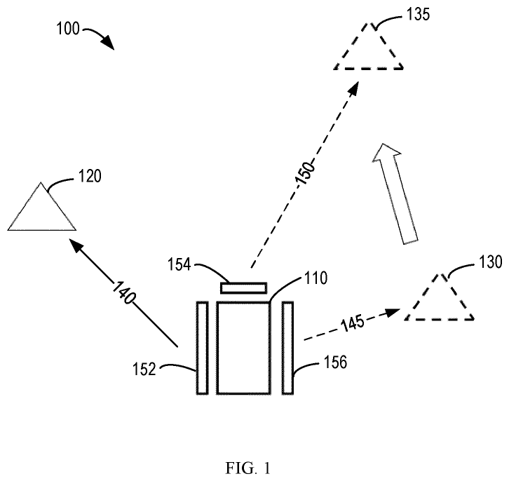

FIG. 1 illustrates an example communication environment 100 in which example embodiments of the present disclosure can be implemented. In the communication environment 100, a plurality of communication devices, including four apparatuses 110, 120, 130 and 135, can communicate with each other. In some embodiments, the apparatuses 110, 120, 130 and 135 will be referred to as a first apparatus 110, a second apparatus 120, a third apparatus 130, and a fourth apparatus 140, respectively. In this example, the first apparatus 110, which may be a terminal device, may simultaneously communicate with two or more of the second, third and fourth apparatuses 120, 130 and 135, which may be network devices such as TRPs or gNBs.

It is to be understood that the number of devices and their connections shown in FIG. 1 are only for the purpose of illustration without suggesting any limitation. The communication environment 100 may include any suitable number of devices configured to implementing example embodiments of the present disclosure.

In the following, for the purpose of illustration, some example embodiments are described with the first apparatus 110 operating as a terminal device and the second and third apparatuses 120 and 130 operating as network devices (for example, TRPs). However, in some example embodiments, operations described with respect to a terminal device may be implemented at a network device or other devices, and operations described with respect to a network device may be implemented at a terminal device or other devices.

In some example embodiments, if the first apparatus 110 is a terminal device and the second apparatus 120, 130, or 140 are network devices, a link from the second or third apparatus 120 or 130 to the first apparatus 110 is referred to as a downlink (DL), while a link from the first apparatus 110 to the second or third apparatus 120 or 130 is referred to as an uplink (UL). If the first, second and third apparatuses 110, 120 and 130 are all terminal devices, a link between these apparatuses is referred to as a sidelink (SL).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Some example embodiments may be implemented in an example scenario of Multi-DCI based multi-TRP operation. For example, the first apparatus 110 (for example, a UE) may perform simultaneous transmissions to two or more of the second, third and fourth apparatuses 120, 130 and 135 (for example, TRPs) via a plurality of channels, for example, via a physical uplink shared channel (PUSCH) or a physical downlink shared channel (PDSCH) 140, 145 and/or 150.

The first apparatus 110 may be provided with multiple APs 152, 154 and 156 and communicate with the second apparatus 120, 130 or 135 using the respective AP 152, 154 or 156. It is to be understood that different APs are shown to be used for different links only for the purpose of illustration, without suggesting any limitation. Alternatively, or in addition, the first apparatus 110 may use different antenna ports or beams in one AP for different links.

In some example embodiments, for multiple TRP communication, if the first apparatus 110 is configured with more than one control resource set (CORESET) pool index (also called CORESETpoolindex) values and/or is configured with multiple TA operation, the first apparatus 110 may be configured with multiple DMRS configuration types, for example, including a first DMRS configuration type and a second DMRS configuration type. Different DMRS types have different density such as different number of resources. In some examples, the methods/schemes herein may be used for S-DCI (single-DCI) based multi-TRP or for any transmission scheme (e.g., also a single TRP) where a dynamic DMRS configuration type indication is needed.

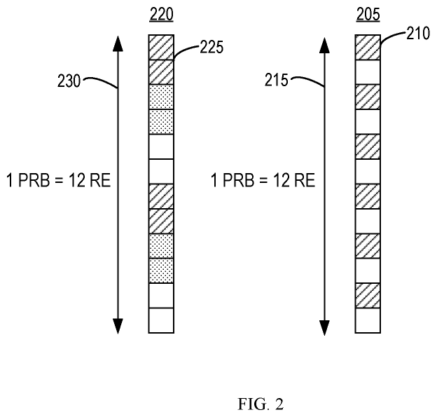

FIG. 2 shows example structures of two DMRS configuration types according to some example embodiments of the present disclosure.

The first DMRS configuration type 205 may be the configuration type 1 where every second RE 210 of REs within a configured PRB 215 is allocated for antenna ports associated with corresponding resources. The second DMRS configuration type 220 may be the configuration type 2 where every 3rd pair of subcarriers 225 is allocated for antenna ports associated with corresponding REs within a configured PRB 230. Accordingly, the first DMRS configuration type may be more robust due to the RE density compared to the second DMRS configuration type.

Different links would require potentially different DMRS configuration types depending on distances or mobility. In this example, as shown in FIG. 1, due to the mobility, the link 145 to the apparatus 130 may be switched towards the apparatus 135 which may have different transmission assumptions (for example, different path loss). In various embodiments of the present disclosure, one or more DMRS configuration types used by the first apparatus 110 may be dynamically indicated or associated via transmission parameters for specific uplink transmission.

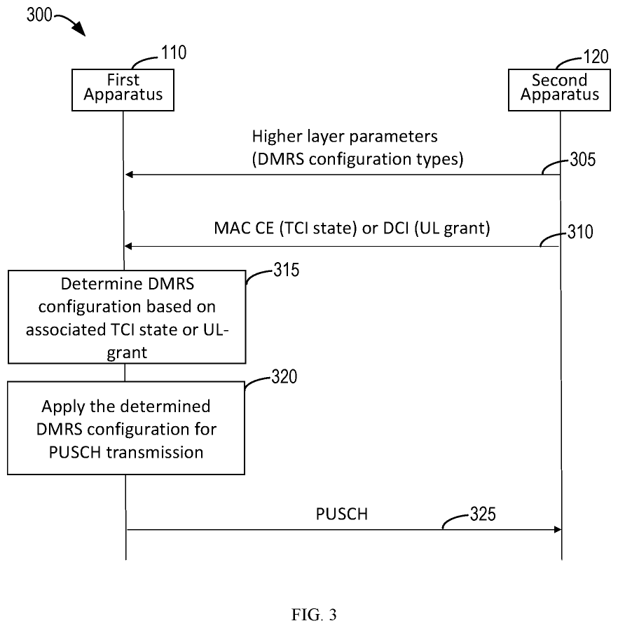

FIG. 3 shows an example signaling diagram of a communication process 300 between the first and second apparatuses 110 and 120 according to some example embodiments of the present disclosure.

As shown in FIG. 3, the first apparatus 110, which may be a UE, may receive (305), from the second apparatus 120, which may be a network node, higher layer parameters including DMRS configuration types.

The first apparatus 110 may also receive (310), from the second apparatus 120, one or more dynamic indication related to one or more DMRS configuration types. The dynamic indication may include a first indication of at least one transmission parameter which may include an indication of a TCI state identification (ID) via a MAC CE. Alternatively, or in addition, the dynamic indication may include a second indication indicative of whether the first or second DMRS configuration type or other DMRS configuration type(s) of the configured DMRS configuration types to be applied. The second indication may be transmitted via a UL grant in DCI.

The first apparatus 110 may determine (315) a DMRS configuration type from the configured DMRS configuration types based on at least one of the first or second indication, for example, based on association of the DMRS configuration type with the TCI state ID or based on the UL grant (e.g., a DCI indication). As an example, the used DMRS configuration type out of the multiple configuration types, which is used for the scheduled uplink transmission, may be based on the indication, in the DCI that schedules the PUSCH transmission, whether the first or the second configured type is applied for the DMRS of the scheduled PUSCH.

Alternatively, or in addition, the indicated TCI ID and/or a TCI state ID configured as the indicated TCI state may be used to determine the DMRS configuration type for the scheduled PUSCH transmission. Then, the apparatus (320) may apply the determined DMRS configuration for PUSCH transmission and then perform (325) the PUSCH transmission. This may be applied to the PDSCH reception in symmetric manner.

Herein, the “indicated TCI state” can be seen as a container/variable taking the values of different TCI state IDs. For example, the first indicated TCI state (for example, index #0) may carry {TCI state ID x}, and the second indicated TCI state (for example, index #1) may carry {TCI state ID y}. If a specific DMRS configuration type is associated with the first indicated TCI state, any TCI state ID x configured as the first indicated TCI state is associated to the specific DMRS configuration type, regardless of what the TCI state ID x and y are. The use of the second indicated TCI state is the same. The specific DMRS configuration type may be determined by using the parameter (for example, the TCI state ID) configured for the first or second indicated TCI state container/variable. If a specific DMRS configuration type is associated with the TCI state ID x or y, it means that the DMRS configuration type is determined based on the value associated with the ID x or y, but not based on the “container/variable” as described above.

It should be understood that the operations or actions as shown in FIG. 3 are only illustrative, but not limited. One operation or action may be split into more operations or actions, and some operations or actions may be integrated into one step. Moreover, there may be also other operations or actions.

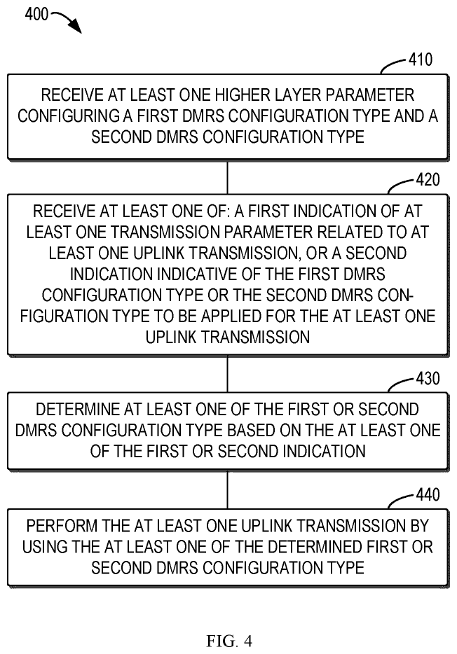

FIG. 4 shows a flowchart of an example method 400 implemented at the first apparatus 110 in accordance with some example embodiments of the present disclosure.

At block 410, the first apparatus 110 receives at least one higher layer parameter configuring a first DMRS configuration type and a second DMRS configuration type. The higher layer parameter may further configure other DMRS configuration types depending on the network configuration.

For example, the first apparatus 110 (for example, a UE) may be configured with one or more (or more than one) PUSCH configurations. These PUSCH configurations may be dedicated to the uplink bandwidth part. Each of the PUSCH configurations may comprise a configuration of a DMRS configuration type.

In case more than one PUSCH configurations are configured for the first apparatus 110, the additional configuration (for example, the second or #2) may be a delta configuration to the first PUSCH configuration or default #1 configuration. The delta configuration may signal only the different parameters between the first (the base configuration) and second configuration (delta). For example, if the configurations have many similar parameters, only those that are different are signaled. The additional configuration may comprise a second value for the DMRS configuration type associated with specific DMRS symbol mapping type to the PUSCH resources (for example, mapping Type A or B).

Alternatively, or in addition, the PUSCH configuration may have additional or second configuration for DMRS mapping type to PUSCH transmission symbols such as the parameters dmrs-UplinkForPUSCH-Mapping TypeA and dmrs-UplinkForPUSCH-Mapping TypeA_additional.

As another example, the first apparatus 110 may receive one PUSCH configuration that indicates or configures the first apparatus 110 with more than one (candidate) values of DMRS configuration types for the specific DMRS symbol mapping for PUSCH transmission symbols. In some example embodiments, the configuration of the DMRS configuration type may be a DMRS configuration type (1+2) indicating that there are 2 candidate values for the DMRS configuration type for a PUSCH transmission with specific type of DMRS mapping to PUSCH transmission symbols. The 2 candidate values are given as an example. In one example, a DMRS configuration type x may indicate that more than one value can be indicated to be used as a DMRS configuration type (e.g., up to N values).

At block 420, the first apparatus 110 receives at least one of: the first indication of at least one transmission parameter related to at least one uplink transmission, or the second indication indicative of the first DMRS configuration type or the second DMRS configuration type to be applied for the at least one uplink transmission.

In some example embodiments, at least one transmission parameters may be pre-associated with one or more DMRS configuration type. In some example embodiments, the first apparatus 110 may receive a configuration of association of the first and/or second DMRS configuration type with at least the at least one transmission parameter. The association may be configured by RRC signaling or MAC CEs (or DCI). The first indication related to the transmission parameter may be received via one of RRC signaling, a MAC CE, or DCI.

For example, the first apparatus 110 may receive a RRC configured association and receive an indication of the associated parameter via a MAC CE or DCI. Alternatively, or in addition, the first apparatus 110 may receive a configuration related to the association via a MAC CE and receive an indication of the associated parameter via DCI.

The associated parameters may include a TCI state ID, an indicated TCI state (for example, index #0 or #1), a reference signal (RS) or a list or RSs, a scheduling offset, timing advance (TA), a CORESET pool index value or a CORESET group index value, a DMRS mapping type, a physical cell identifier (PCI), and/or the like. Based on the configured association of a specific DMRS configuration type and the indicated parameter, the specific DMRS configuration type may be determined to be used.

The second indication that which DMRS configuration type is to be applied may be received via DCI. The DCI may schedule whether the first or the second configured type is applied for the DMRS of the scheduled PUSCH.

Alternatively, the DCI that does not schedule any UL transmission (for example, without data grant) can be used to trigger the used DMRS configuration type value for the associated PUSCH transmission, for example, based on the CORESETpoolindex/CORESET group index value/ID (e.g. CORESETgroupindex). For example, how to apply the DMRS configuration type could depend on the CORESETpoolindex/CORESETgroupindex. Any UL transmission scheduled using the CORESETs of specific pool index may use the indicated DMRS type.

Alternatively, such DCI may trigger the DMRS configuration type value based on the indicated TCI state that was used to schedule the DCI. As an example, if a DCI scheduling the PUSCH transmission uses the indicated TCI state, a specific value that has been associated with the indicated TCI state (or the TCI state ID) is used for the scheduled uplink transmission (first or second indicated TCI state). Alternatively, or additionally, such an indication may be used to semi-persistently trigger the DMRS association. Any UL transmission made after the DCI indication may follow the indicated type.

At block 430, the first apparatus 110 determines at least one of the first or second DMRS configuration type based on the at least one of the first or second indication. The use of the first and second indications may be based on predefined or configured rules.

The applied or used DMRS configuration type may depend on an indicated TCI state. In some example embodiments, the first or the second DMRS configuration type may be determined based on the configured or associated type with an indicated TCI state. The first or the second DMRS configuration type may be applied to a TCI state ID configured as the indicated TCI state. For example, if there is configured or indicated association with the first or the second indicated TCI state (or #0 and #1), regardless of the actual TCI state ID, the first apparatus 110 may use a DMRS configuration type associated with the first and the second indicated TCI state.

In this case, the configuration type is associated with the indicated TCI state. The TCI state ID can vary. For example, the TCI state ID configured as the indicated TCI state may be changed, but the DMRS configuration type comes from the TCI state ID that is associated with the indicated TCI state. Thus, for the indicated TCI states, the DMRS configuration type may be either 1 or 2 based on the dynamic indication. Since in the multi-TRP (or mTRP) operation, the TRP may change in a rather dynamic fashion, the dynamic operation may bring more benefits.

In some example embodiments, the association can be given in the TCI state ID configuration (rather than associating the DMRS configuration type to the indicated TCI state). Based on the association of a TCI state ID and the first DMRS configuration type, the first apparatus 110 may determine the first DMRS configuration type upon receiving the first indication of the TCI state ID. By way of example, for the specific TCI state or TCI states, depending on which TCI state(s) are indicated to be the indicated (unified) TCI states, the first apparatus 110 may apply either the first or second DMRS configuration type. In one example, the currently indicated TCI states may have the same DMRS configuration type or different DMRS configuration types.

Alternatively, or in addition, the DMRS configuration type may be determined based on a scheduling offset of the uplink transmission. In some example embodiments, if the first DMRS configuration type (or a default DMRS type configuration) is configured to be associated to a scheduling offset is less than a threshold offset (which may be configured or indicated depending on the network implementation), the first apparatus 110 may determine the first DMRS configuration type upon receiving the first indication of the scheduling offset that is less than a threshold offset. For example, if the scheduling offset for the PUSCH transmission is less than the configured threshold offset value (such as K2 value, defined in slots), the first apparatus 110 may apply a default DMRS configuration type. The default value may be the first DMRS configuration type value (instead of the additional DMRS configuration type value or the default value may fixed in specification or be either the first or second or the Nth type value).

The applied DMRS configuration type (e.g., type 1 or type 2) for the uplink transmission may depend on the TA value associated with/applies for the transmission. In some example embodiments, if the first DMRS configuration type is configured to be associated to a TA with a value equal to or greater than a first threshold time value and less than a second threshold value, the first apparatus 110 may determine the first DMRS configuration type upon receiving the first indication of such a TA.

As an example, when the TA>=0 (TA=0 may mean that no TA is used and the UE may be in the cell center or the cell may be small (TA>0)) but less than the TA-threshold-for-DMRStype, the first configuration type (for example, the type 1) may be used (as the type2 which is less robust but has higher multiplexing capability). Otherwise, the second configuration type is used. In this example, the first threshold time value is 0, and the second threshold time value is TA-threshold-for-DMRStype. Other threshold time values may be used depending on the network implementations.

In some example embodiments, the dynamic indication of DMRS configuration type(s) can be configured individually for PUSCH DMRS mapping type A or B. In some example embodiments, the DMRS configuration type may be specific for the PCI value associated with the RS or the source RS of the TCI state. The association to the PCI may be configured.

In some example embodiments, the first apparatus 110 may receive configuration for one or more lists of reference signals for which the use of a specific DMRS type is associated. For example, if two sets (or lists) of reference signals are associated with the first and second configuration type, respectively, then the associated first configuration type may be used for a first set (or list) of reference signals and the associated second configuration type may be used for a second set (or list) of reference signals. If a used reference signal is not listed in the first or second list (or set), a default value of the configuration type may be used. The default value may be predefined.

The reference signals may be indicated by the reference signals of the indicated TCI states, or SRS resource indicators that are associated with the PUSCH transmission, or the QCL source/spatial relation of the indicated TCI state/SRS. The reference signals in the first and/or second list may be compared to the indicated reference signals. If the RS associated with PUSCH transmission matches with the first or second list, the associated DMRS configuration type may be used for the PUSCH transmission.

In some example embodiments, if the first apparatus 110 receives both the first indication of a transmission parameter and the second indication of the used DMRS configuration type, the first apparatus 110 may choose to follow the second indication and select the first DMRS configuration type. For example, after the associated transmission parameter is configured via RRC signaling or indicated via a MAC CE or an earlier DCI, the network may change the scheduling of the DMRS configuration type and indicate a currently used DMRS configuration type via a later DCI. This may further provide more flexibility.

At block 440, the first apparatus 110 performs the at least one uplink transmission by using the at least one of the determined first or second DMRS configuration type. In some example embodiments, two simultaneous uplink transmissions may be performed based on the at least one of the first and second DMRS configuration types. The simultaneous UL transmissions may use multiple antenna panels or multiple beams per panel.

By way of example, the first apparatus 110 may be scheduled with two PUSCH transmission occasions for simultaneous PUSCH transmissions from two antenna panels in spatial division multiplexing (SDM) manner. The first apparatus 110 may determine the DMRS configuration type for the first PUSCH occasion based on the (RRC) configuration and the DMRS apparatus 110 type for the second PUSCH occasion from the dynamic indication included in the DCI triggering or scheduling the PUSCH transmission occasions.

If a dynamic DMRS configuration type is configured for the first apparatus 110, but no indication is via DCI or MAC CE or no association is provided via TCI state, the first apparatus 110 may assume a default value for the DMRS configuration type. In some example embodiments, the first apparatus 110 may perform a further uplink transmission based on a default DMRS configuration type without the at least one of the first or second indication. The default value is a predefined value for the cell. Alternatively, or in addition, the default value may be dependent on the PCI or PCI specific.

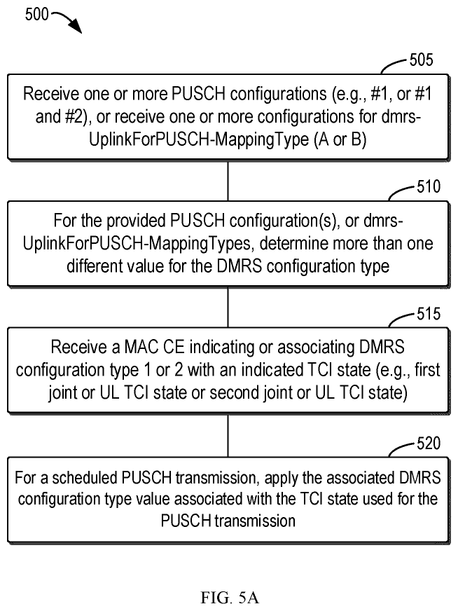

Example dynamic indication processes for DMRS configuration types will be described below with reference to FIGS. 5A and 5B.

FIG. 5A shows an example process 500 where a MAC CE is used to enable the dynamic indication according to some example embodiments of the present disclosure.

In the process 500, multiple PUSCH configurations or multiple dmrs-UplinkForPUSCH-MappingTypes are provided to the first apparatus 110 by RRC and associated with the TCI state ID or the indicated (unified)TCI state for each uplink transmission.

As shown in FIG. 5A, at block 505, the first apparatus 110 may receive one or more PUSCH configurations (e.g., #1, or #1 and #2) or receive one or more configurations for dmrs-UplinkForPUSCH-MappingType (A or B). At block 510, for the provided PUSCH configuration(s), or dmrs-UplinkForPUSCH-MappingTypes, the first apparatus 110 may determine more than one different value for the DMRS configuration type. At block 515, the first apparatus 110 may receive a MAC CE indicating or associating DMRS configuration type 1 or 2 with an indicated TCI state (e.g., first joint or UL TCI state or second joint or UL TCI state). At block 520, for a scheduled PUSCH transmission, the first apparatus 110 may apply the associated DMRS configuration type value associated with the TCI state used for the PUSCH transmission.

FIG. 5B shows an example process 530 where DCI is used to enable the dynamic indication according to some example embodiments of the present disclosure.

In the process 530, the DCI signaling may indicate for the scheduled PUSCH transmission which DMRS configuration type is used.

As shown in FIG. 5B, at block 535, the first apparatus 110 may receive a PUSCH configuration (or more than one PUSCH configuration) with more than one value for different DMRS configuration types. At block 540, for the provided PUSCH configuration(s), the first apparatus 110 may determine more than one different candidate value for the DMRS configuration type for the specific type of DMRS mapping type. At block 545, the first apparatus 110 may determine the used DMRS configuration type value for the current PUSCH transmission based on the indicated value of the DMRS configuration type in DCI scheduling the PUSCH transmission. At block 550, for the scheduled PUSCH transmission, the first apparatus 110 may apply the associated DMRS configuration type value indicated by the one or more PUSCH configuration.

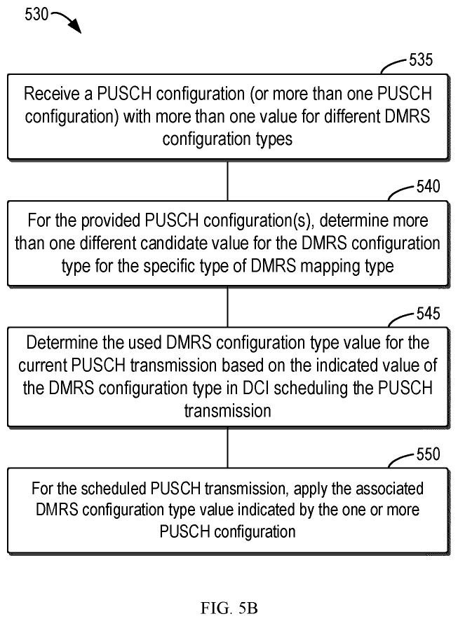

FIG. 6 shows a flowchart of an example method 600 implemented at the second, third or fourth apparatus 120, 130 or 135 in accordance with some example embodiments of the present disclosure. For the purpose of discussion, the method 600 will be described from the perspective of the second apparatus 120 in FIG. 1.

At block 610, the second apparatus 120 transmits at least one higher layer parameter configuring a first DMRS configuration type and a second DMRS configuration type. At block 620, the second apparatus 120 determines at least one of the first or second DMRS configuration type for at least one uplink transmission. At block 630, the second apparatus 120 transmits at least one of: a first indication of at least one transmission parameter related to the at least one uplink transmission, or a second indication indicative of the first DMRS configuration type or the second DMRS configuration type to be applied for the at least one uplink transmission. At block 640, the second apparatus 120 receives the at least one uplink transmission by using the determined at least one of the first or second DMRS configuration type.

In some example embodiments, the second apparatus 120 may transmit a configuration of association of the first and/or second DMRS configuration type with at least the at least one transmission parameter.

In some example embodiments, the at least one transmission parameter may comprise at least one of: a transmission configuration indicator (TCI) state identification (ID), an indicated TCI state, a reference signal, a scheduling offset, timing advance, a control resource set (CORESET) pool index value or a CORESET group index value, a DMRS mapping type, or a physical cell identifier.

In some example embodiments, the indicated TCI state may be transmitted if the determined at least one of the first or second DMRS configuration type is configured or associated with the indicated TCI state, and the first or the second DMRS configuration type may be applied to a TCI state ID configured as the indicated TCI state.

In some example embodiments, the TCI state ID associated with the first DMRS configuration type may be transmitted if the first DMRS configuration type is determined.

In some example embodiments, the first indication of the scheduling offset less than a threshold offset may be transmitted if the first DMRS configuration type is determined.

In some example embodiments, the first indication of the timing advance equal to or greater than a first threshold time value and less than a second threshold value may be transmitted if the first DMRS configuration type is determined.

In some example embodiments, the first indication may be transmitted via one of RRC signaling, a MAC CE, or DCI, and/or the second indication is transmitted via the DCI or MAC CE.

In some example embodiments, the at least one uplink transmission may comprise two simultaneous uplink transmissions based on the at least one of the first and second DMRS configuration types.

In some example embodiments, the second apparatus 120 may receive a further uplink transmission based on a default DMRS configuration type of the first and second DMRS configuration types without the at least one of the first or second indication.

In some example embodiments, an apparatus capable of performing the method 400 (for example, the first apparatus 110 in FIG. 1) may comprise means for performing the respective operations of the method 400. The means may be implemented in any suitable form. For example, the means may be implemented in a circuitry or software module. The apparatus may be implemented as or included in the first apparatus 110 in FIG. 1.

In some example embodiments, the apparatus comprises means for receiving at least one higher layer parameter configuring a first demodulation reference signal (DMRS) configuration type and a second DMRS configuration type; means for receiving at least one of: a first indication of at least one transmission parameter related to at least one uplink transmission, or a second indication indicative of the first DMRS configuration type or the second DMRS configuration type to be applied for the at least one uplink transmission; means for determining at least one of the first or second DMRS configuration type based on the at least one of the first or second indication; and means for performing the at least one uplink transmission by using the at least one of the determined first or second DMRS configuration type.

In some example embodiments, the apparatus further comprises: means for receiving a configuration of association of the first and/or second DMRS configuration type with at least the at least one transmission parameter.

In some example embodiments, the at least one transmission parameter comprises at least one of: a transmission configuration indicator (TCI) state identification (ID), an indicated TCI state, a reference signal, a scheduling offset, means for timing advance, a control resource set (CORESET) pool index value or a CORESET group index value, a DMRS mapping type, or a physical cell identifier.

In some example embodiments, the first or the second DMRS configuration type is determined based on the configured or associated type with an indicated TCI state, and wherein the first or the second DMRS configuration type is applied to a TCI state ID configured as the indicated TCI state.

In some example embodiments, the means for determining the first or second DMRS configuration type comprises: means for in response to receiving the TCI state ID, determining the first DMRS configuration type based on the association of the TCI state ID and the first DMRS configuration type.

In some example embodiments, the means for determining the first or second DMRS configuration type comprises: means for in response to receiving the first indication of the scheduling offset, determining the first DMRS configuration type if the scheduling offset is less than a threshold offset.

In some example embodiments, the means for determining the first or second DMRS configuration type comprises: means for in response to receiving the first indication of the timing advance, determining the first DMRS configuration type if a value of the timing advance is equal to or greater than a first threshold time value and less than a second threshold value.

In some example embodiments, the means for determining the first or second DMRS configuration type comprises: means for in response to receiving the first and second indications, determining the first DMRS configuration type based on the second indication.

In some example embodiments, the first indication is received via one of Radio Resource Control (RRC) signaling, a media access control (MAC) control element (CE), downlink control information (DCI), and/or the second indication is received via a DCI or MAC CE.

In some example embodiments, the at least one uplink transmission comprises two simultaneous uplink transmissions based on the at least one of the first and second DMRS configuration types.

In some example embodiments, the apparatus further comprises: means for performing a further uplink transmission based on a default DMRS configuration type without the at least one of the first or second indication.

In some example embodiments, the apparatus further comprises means for performing other operations in some example embodiments of the method 400 or the first apparatus 110. In some example embodiments, the means comprises at least one processor; and at least one memory storing instructions that, when executed by the at least one processor, cause the performance of the apparatus.

In some example embodiments, an apparatus capable of performing the method 600 (for example, the second apparatus 120 in FIG. 1 may comprise means for performing the respective operations of the method 600. The means may be implemented in any suitable form. For example, the means may be implemented in a circuitry or software module. The apparatus may be implemented as or included in the second apparatus 120 in FIG. 1.

In some example embodiments, the apparatus comprises means for transmitting at least one higher layer parameter configuring a first demodulation reference signal (DMRS) configuration type and a second DMRS configuration type; means for determining at least one of the first or second DMRS configuration type for at least one uplink transmission; means for transmitting at least one of: a first indication of at least one transmission parameter related to the at least one uplink transmission, or a second indication indicative of the first DMRS configuration type or the second DMRS configuration type to be applied for the at least one uplink transmission; means for receiving the at least one uplink transmission by using the determined at least one of the first or second DMRS configuration type.

In some example embodiments, the apparatus further comprises: means for transmitting a configuration of association of the first and/or second DMRS configuration type with at least the at least one transmission parameter.

In some example embodiments, the at least one transmission parameter comprises at least one of: a transmission configuration indicator (TCI) state identification (ID), an indicated TCI state, a reference signal, a scheduling offset, means for timing advance, a control resource set (CORESET) pool index value or a CORESET group index value, a DMRS mapping type, or a physical cell identifier.

In some example embodiments, the indicated TCI state is transmitted if the determined at least one of the first or second DMRS configuration type is configured or associated with the indicated TCI state, and wherein the first or the second DMRS configuration type is applied to a TCI state ID configured as the indicated TCI state.

In some example embodiments, the TCI state ID associated with the first DMRS configuration type is transmitted if the first DMRS configuration type is determined.

In some example embodiments, the first indication of the scheduling offset less than a threshold offset is transmitted if the first DMRS configuration type is determined.

In some example embodiments, the first indication of the timing advance equal to or greater than a first threshold time value and less than a second threshold value is transmitted if the first DMRS configuration type is determined.

In some example embodiments, the first indication is transmitted one of Radio Resource Control (RRC) signaling, a media access control (MAC) control element (CE), downlink control information (DCI), and/or the second indication is transmitted via the DCI or MAC CE.

In some example embodiments, the at least one uplink transmission comprises two simultaneous uplink transmissions based on the at least one of the first and second DMRS configuration types.

In some example embodiments, the apparatus further comprises: means for receiving a further uplink transmission based on a default DMRS configuration type of the first and second DMRS configuration types without the at least one of the first or second indication.

In some example embodiments, the apparatus further comprises means for performing other operations in some example embodiments of the method 600 or the second apparatus 120. In some example embodiments, the means comprises at least one processor; and at least one memory storing instructions that, when executed by the at least one processor, cause the performance of the apparatus.

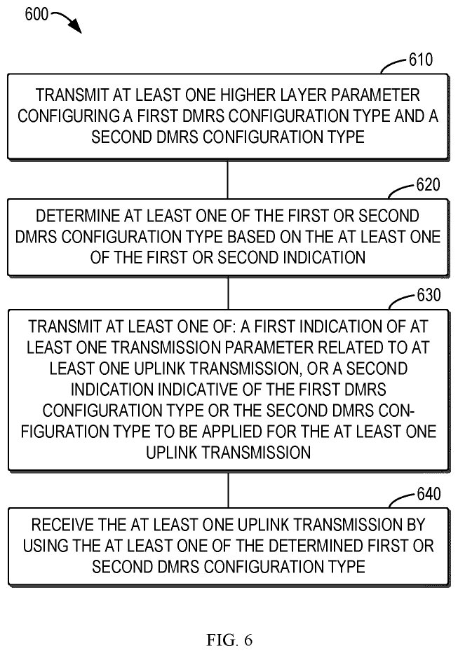

FIG. 7 is a simplified block diagram of an apparatus 700 that is suitable for implementing example embodiments of the present disclosure. The apparatus 700 may be provided to implement a communication device, for example, the first apparatus 110 or the second, third or fourth apparatus 120, 130 or 135 as shown in FIG. 1. As shown, the apparatus 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The apparatus 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the apparatus 700 may perform any process of the disclosure as discussed with reference to FIG. 1 to FIG. 6. The example embodiments of the present disclosure may also be implemented by hardware or by a combination of software and hardware.

In some example embodiments, the program 730 may be tangibly contained in a computer readable medium which may be included in the apparatus 700 (such as in the memory 720) or other storage devices that are accessible by the apparatus 700. The apparatus 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

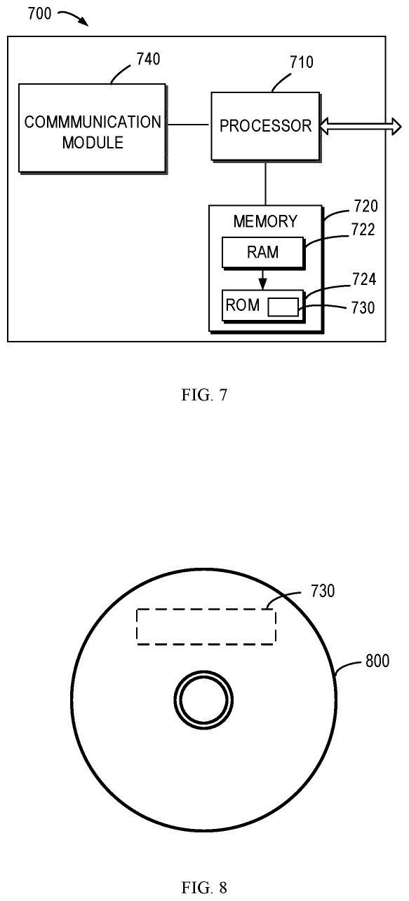

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-21. (canceled)

22. An apparatus, comprising:
at least one processor; and
at least one memory storing instructions that, when executed by the at least one processor, cause the apparatus at least to perform:
receiving at least one higher layer parameter configuring a first demodulation reference signal (DMRS) configuration type and a second DMRS configuration type;
receiving at least one of:
a first indication of at least one transmission parameter related to at least one uplink transmission, or
a second indication indicative of the first DMRS configuration type or the second DMRS configuration type to be applied for the at least one uplink transmission;
determining at least one of the first or second DMRS configuration type based on the at least one of the first or second indication; and
performing the at least one uplink transmission by using the at least one of the determined first or second DMRS configuration type.

23. The apparatus of claim 22, wherein the apparatus is further caused to perform:
receiving a configuration of association of at least one of the first or second DMRS configuration type with at least the at least one transmission parameter.

24. The apparatus of claim 22, wherein the at least one transmission parameter comprises at least one of:
a transmission configuration indicator (TCI) state identification (ID),
an indicated TCI state,
a reference signal,
a scheduling offset,
timing advance,
a control resource set (CORESET) pool index value or a CORESET group index value,
a DMRS mapping type, or
a physical cell identifier.

25. The apparatus of claim 24, wherein at least one of the first or the second DMRS configuration type is determined based on the configured or associated type with an indicated TCI state, and wherein the first or the second DMRS configuration type is applied to a TCI state ID configured as the indicated TCI state.

26. The apparatus of claim 24, wherein,
in response to receiving the TCI state ID, the first DMRS configuration type is determined based on the association of the TCI state ID and the first DMRS configuration type.

27. The apparatus of claim 24, wherein,
in response to receiving the first indication of the scheduling offset, the first DMRS configuration type is determined if the scheduling offset is less than a threshold offset.

28. The apparatus according to claim 22, wherein
the first indication is received via one of Radio Resource Control (RRC) signaling, a media access control (MAC) control element (CE), or downlink control information (DCI), and/or
the second indication is received via a DCI or MAC CE.

29. A method comprising:
receiving at least one higher layer parameter configuring a first demodulation reference signal (DMRS) configuration type and a second DMRS configuration type;
receiving at least one of:
a first indication of at least one transmission parameter related to at least one uplink transmission, or
a second indication indicative of the first DMRS configuration type or the second DMRS configuration type to be applied for the at least one uplink transmission;
determining at least one of the first or second DMRS configuration type based on the at least one of the first or second indication; and
performing the at least one uplink transmission by using the at least one of the determined first or second DMRS configuration type.

30. The method of claim 29, further comprising:
receiving a configuration of association of the first and/or second DMRS configuration type with at least the at least one transmission parameter.

31. The method of claim 29, wherein the at least one transmission parameter comprises at least one of:
a transmission configuration indicator (TCI) state identification (ID),
an indicated TCI state,
a reference signal,
a scheduling offset,
timing advance,
a control resource set (CORESET) pool index value or a CORESET group index value,
a DMRS mapping type, or
a physical cell identifier.

32. The method of claim 31, wherein at least one of the first or the second DMRS configuration type is determined based on the configured or associated type with an indicated TCI state, and wherein the first or the second DMRS configuration type is applied to a TCI state ID configured as the indicated TCI state.

33. The method of claim 31, wherein,
in response to receiving the TCI state ID, the first DMRS configuration type is determined based on the association of the TCI state ID and the first DMRS configuration type.

34. The method of claim 31, wherein,
in response to receiving the first indication of the scheduling offset, the first DMRS configuration type is determined if the scheduling offset is less than a threshold offset.

35. The method according to claim 29, wherein
the first indication is received via one of Radio Resource Control (RRC) signaling, a media access control (MAC) control element (CE), or downlink control information (DCI), and/or
the second indication is received via a DCI or MAC CE.

36. A non-transitory computer readable medium comprising instructions stored thereon for causing an apparatus at least to perform:
receiving at least one higher layer parameter configuring a first demodulation reference signal (DMRS) configuration type and a second DMRS configuration type;
receiving at least one of:
a first indication of at least one transmission parameter related to at least one uplink transmission, or
a second indication indicative of the first DMRS configuration type or the second DMRS configuration type to be applied for the at least one uplink transmission;
determining at least one of the first or second DMRS configuration type based on the at least one of the first or second indication; and
performing the at least one uplink transmission by using the at least one of the determined first or second DMRS configuration type.

37. The non-transitory computer readable medium of claim 36, the instructions further causing the apparatus to perform:
receiving a configuration of association of the first and/or second DMRS configuration type with at least the at least one transmission parameter.

38. The non-transitory computer readable medium of claim 37, wherein the at least one transmission parameter comprises at least one of:
a transmission configuration indicator (TCI) state identification (ID),
an indicated TCI state,
a reference signal,
a scheduling offset,
timing advance,
a control resource set (CORESET) pool index value or a CORESET group index value,
a DMRS mapping type, or
a physical cell identifier.

39. The non-transitory computer readable medium of claim 38, wherein at least one of the first or the second DMRS configuration type is determined based on the configured or associated type with an indicated TCI state, and wherein the first or the second DMRS configuration type is applied to a TCI state ID configured as the indicated TCI state.

40. The non-transitory computer readable medium of claim 38, wherein,
in response to receiving the TCI state ID, the first DMRS configuration type is determined based on the association of the TCI state ID and the first DMRS configuration type.

41. The non-transitory computer readable medium of claim 38, wherein,
in response to receiving the first indication of the scheduling offset, the first DMRS configuration type is determined if the scheduling offset is less than a threshold offset.
